(19) United States
(12) Patent Application Publication
(10) Pub. No.: US 2006/0286516 A1
(43) Pub. Date: Dec. 21, 2006

(54) Method for ensuring employees safe work readiness

(76) Inventors: Paul Michels, Virginia Beach, VA (US); Susan Delong, Norfolk, VA (US); Michael L. Welsh, Spring, TX (US)

Correspondence Address: John H. Thomas, P.C., 536 Granite Avenue, Richmond, VA, 23226, US

(21) Appl. No.: 11/140,215

(22) Filed: May 27, 2005

(51) Int. Cl. G09B 19/00

(52) U.S. Cl. 434/219

(57) ABSTRACT

The present method provides online workforce readiness tracking of pertinent safety status information to safety professionals that is immediate, accurate, documented, verifiable, auditable and easily accessible for all authorized Users. All data is stored online, in one Secure Socket Layer (SSL) database location. The online system provides a ‘real time’ process of safety status validation and verification at multiple User access levels, dependent upon the specific safety information required, in order to determine compliance, as defined by the Owner's work readiness requirements, per Project Site. The present system simplifies and reduces the redundant costs associated with safe work preparedness—specifically, safety training, drug testing, Employee verifications or background checks.

The present invention is directed to improvements in existing safety-readiness certification programs. Specifically, the programs include the use of a safety advisory board and the use of entry scan systems to ensure worker compliance with safety testing.

### BACKGROUND

Workplace safety is a significant priority for all manufacturing facilities. Safety training and other workplace readiness testing are a part of all responsible facilities. Such training and testing have been instituted for many years and have been successful particularly in connection with stationary work forces.

In more recent times, the work force has become more flexible and mobile. In the example of the construction industry, different teams of specialized workers may work at multiple sites over multiple days. There is no longer the stationary or relatively stationary work assignment. This means that workers may be subjected to different sites having potentially different safety hazards. It also means that employers see different workers/employees on their sites and have no knowledge of the work safety readiness of those workers.

Work safety readiness is typically ensured by the sponsor of a worker or a group of workers/employees. The sponsors may include contractors and labor unions for various work specialties including electrical, plumbing, welding, etc. The sponsors will typically provide some training, including safety training, for their workers/employees, but that training often is not organized or systematic. As a work force turns over, there is difficultly in knowing the amount of training of each of the workers. With respect to some safety issues such as drug testing, some workers may try to cheat the system so as to avoid readiness testing. At other times, workers may be inadvertently untrained for various job safety issues.

One solution to safety training is a certification program. One example is an online verification system for ensuring a worker's safety readiness. The system documents, tracks, and immediately validates (or does not validate) a worker's safe work readiness status. The particular work safety readiness and certification may be defined by the sponsor. Access to the work readiness status may be available wherever there is an internet connection. The system also has different “views” to the system so that workers, sponsors, and employers, for instance, may all have different levels of access to the information.

### SUMMARY

Accordingly, it is an object of the present invention to improve existing verification systems and to improve the quality of safety education and discussion. Further, it is desirable to improve worker tracking with respect to safety.

In one example, a method for ensuring employees safe work readiness comprises the step of providing a computer processing hub adapted to store information regarding an employee in a hub database. The method further includes providing an advisory board of a plurality of members comprising safety-involved professionals, the advisory board having access to the computer processing hub. The method further includes providing a plurality of safety-related instructional courses reviewed by the advisory board and administering a safety related instructional course to an employee. Further the method includes verifying the identity of an employee and administering a test related to safety-related subject matter to the employee and evaluating the test results to determine a score for the employee's test answers, and storing the test results in the processing hub database making the test results available to an employer that is evaluating the employee's safe work readiness. Still further, the method includes making the employee's test results available to the employee and allowing the employee to ask questions to the advisory board regarding the safety-related subject matter, whereby an employer and employee may use the computer processing hub as an informational resource in the field of safe work readiness. The computer processing hub may comprise a plurality of categories of viewing access. The computer processing hub may be a website server, and the information stored in the hub database may be available on an internet website. The method may further include, after an employee has obtained at least a predetermined score on a predetermined number of tests, certifying the safe work readiness of the employee. Still further, different employers may select different scores on the predetermined test before declaring safe work readiness of an employee or they may require different predetermined tests before declaring safe work readiness of the employee.

In another example, a method for ensuring employees safe work readiness at an employer job site comprises the steps of providing a computer processing hub adapted to store information regarding an employee in a hub database. The method further includes providing a plurality of safety-related instructional courses and administering a safety-related instructional course to an employee. The method also includes verifying the identity of an employee and administering a test related to the safety-related subject matter to the employee and evaluating the test results to determine the score of the employee's test answers, and storing the test results in the hub database. An employee is provided with an identification card that is adapted to be scanned. The method further includes providing an entry scan system at an employer's job site, the scanned system adapted to read the employee's identification card, and using the entry scan system, confirming that each employee at the employer job site is safe work ready.

### BRIEF DESCRIPTION OF THE DRAWINGS

FIG. 1 is a flow chart illustrating the flow of information and inquiries into and out of a computer processing hub in accordance with an example described herein.

FIG. 2 is a flow chart showing an example of administering a safety-related instructional course and a corresponding test related to the course.

FIG. 3 is a flow chart showing an example of the operation of an entry scan system that ensures safe work readiness.

FIG. 4 is a flow chart showing an example of components and their interaction in a computer processing hub.

### DETAILED DESCRIPTION

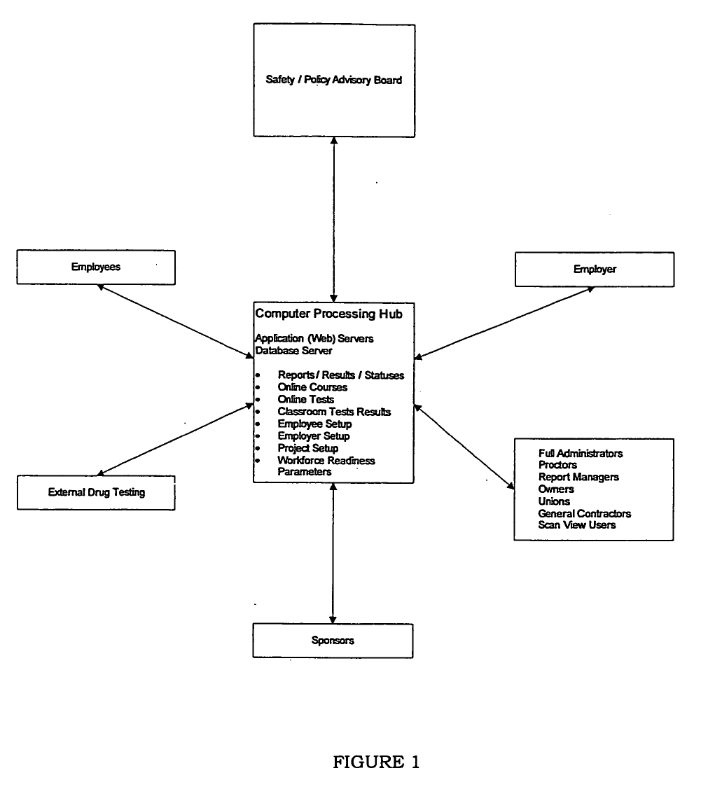

The present invention is directed to significant improvements over existing, safety-readiness certification systems. The present system includes a computer processing hub that is adapted to store information regarding an employee/worker in a hub data base. (The terms “employee” and “worker” are used interchangeably herein). An advisory board of one or more members involved in the field of safety are assembled. This advisory board has access to the computer processing hub. One or more safety-related instructional courses are reviewed by the advisory board. These courses are administered to relevant workers. After the courses have been taken by the workers, the workers are given a test that relates to the safety-related subject matter of the course. The test results are evaluated to determine a score for the employee's test answers, and those test results are stored in the computer processing hub database. Those test results then become available to an employer that is evaluating an employee's safe work readiness. The employees as well as the employers are allowed to ask questions to the advisory board regarding safety-related subject matter. In this way, the subject matter of the safety courses and related test results may be improved and enhanced. The advisory board becomes a resource not only to the testing authority, for instance a sponsor or employer, but also to the employees themselves. FIG. 1 illustrates the flow of information in an example described herein.

A computer processing hub acts as a storage device for storing hub database information including information about various workers/employees. The computer processing hub is further connected via a wide area network such as the internet to other computers in order to make the database information available to interested and authorized parties.

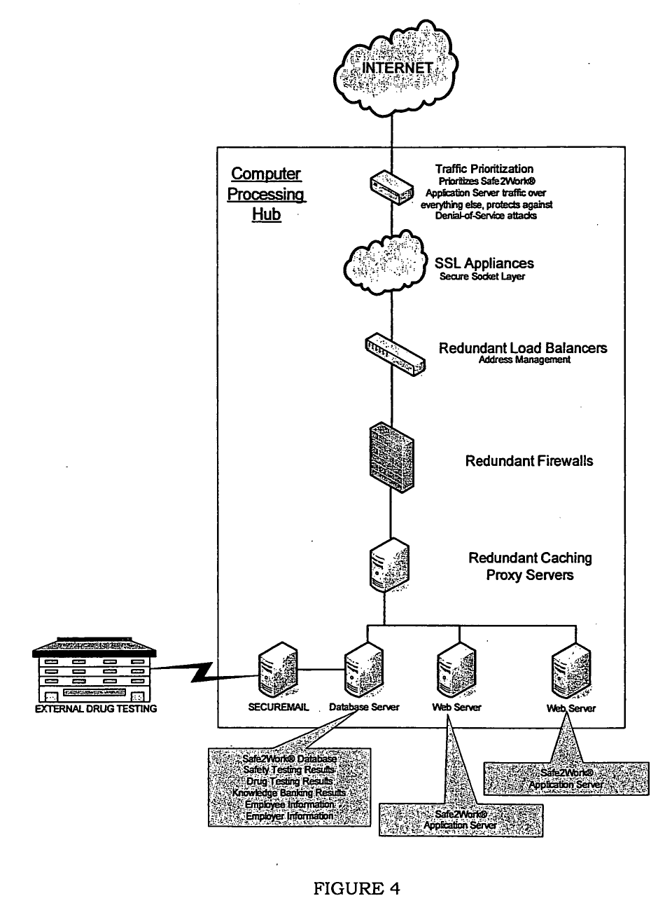

FIG. 4 illustrates an example of the component parts of a computer processing hub. There may be separate database and application servers to enhance operation of the system. The “Safe2Work” database refers to a safety training certification and online verification program. Redundancy is built into the system to protect and preserve the information and the operation of the system. Security components such as a securemail server, firewalls, load balances, SSL appliances, and a traffic prioritizer all protect the operation and confidentiality of the system and the system efficiency.

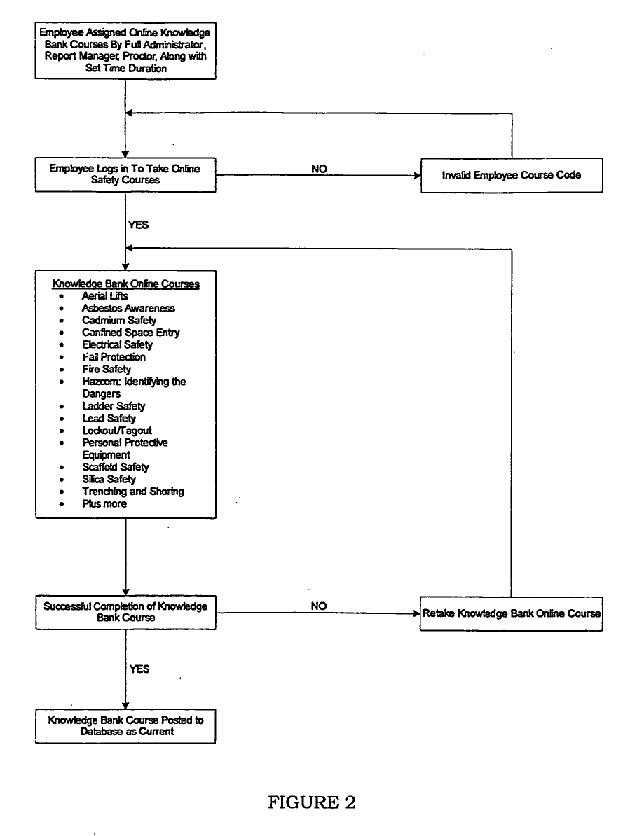

The safety-related instructional courses and testing may take place at fixed locations. Workers may be given CDs to view courses at their convenience. The courses and testing may alternatively take place online. It is essential that any testing that is based on the courses include verification of the identity of a worker taking a test. Adequate verification systems may include human instructors that confirm identity of a worker taking a test. Other types of security may also be used. The safety related courses and testing may relate to topics such as specific types of work specialties. In one example, available courses and tests (in English and Spanish) are in the following areas: Aerial Lifts, Asbestos Awareness, Cadmium Safety, Confined Space Entry, Electrical Safety, Fall Protection, Fire Safety, Hazcom: Identifying the Dangers, Ladder Safety, Lead Safety, Lockout/Tagout, Personal Protective Equipment, Scaffold Safety, Silica Safety, and Trenching and Shoring. The courses may also relate to drugs and drug testing and to life saving techniques such as CPR. FIG. 2 illustrates the steps of how a course may be taken and tested online.

Not every worker/employee needs to complete and pass a test for every safety course. It is possible for an employer to identify the specific courses and tests to be completed by particular employees. In other words, different employers may require different predetermined tests be completed and passed before declaring safe work readiness of an employee. Still further, different employers may select different scores be achieved on the predetermined tests before declaring safe work readiness of an employee. The foregoing are merely examples of how the system may be used to ensure safe work readiness in general and for specific job sites.

A traditional method of administering courses includes providing courses on CDs and the employee then tests online. This will always be available for those that prefer CDs. When the online tests are taken, they are proctored, and thus the results are verifiable and documented. However, courses may be taken online via a simple coding system that can set up easily. Embedded questions are used so that as one moves through the course, if a question is answered incorrectly, the Employee is remediated back to the course section where the information is covered. Then, once the section is reviewed, they are then given the opportunity to answer the question correctly. They must answer the question correctly before they can continue through the course. They can leave the course at anytime and be bookmarked if they care to resume, at a later time, in the same place. When the course is completed a Knowledge Banked status and date will appear and that will designate that the course has been completed but the Employee has not mastered the online test via a Proctor.

The test scores from the safety-related testing are all stored in the hub data base. The hub database is a central clearing house made accessible by employees/workers, sponsors, and employers. Others may also have access. In a preferred example, these different classes of individuals will have different levels of access to the information. In this way, the security and confidentiality of the testing is preserved.

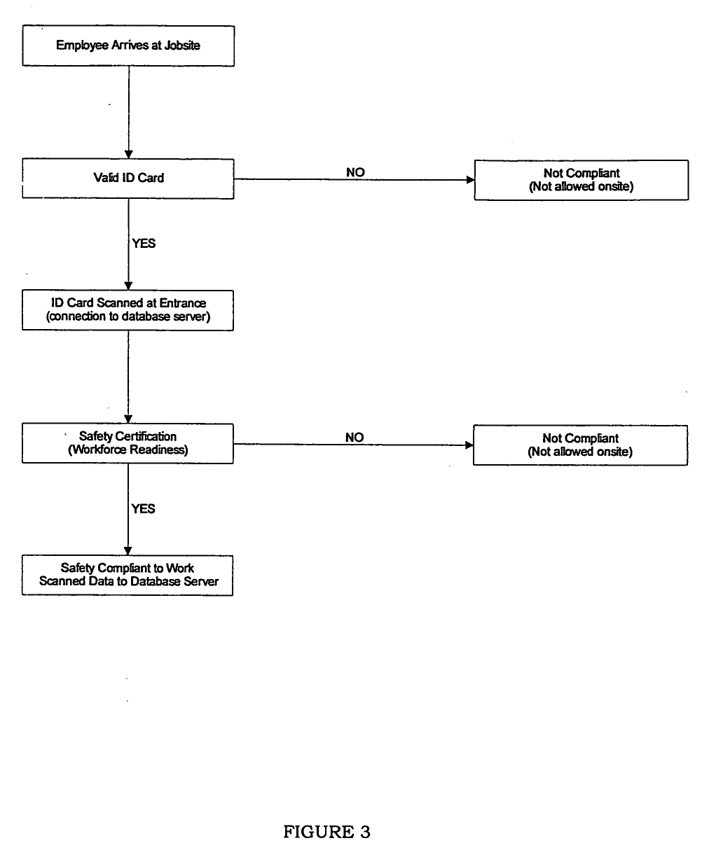

In one example of the present invention, the system of safety-readiness certification includes a mechanism for real-time identification and safety certification. In this alternative, a worker/employee is issued a unique identification card. The card may include a magnetic strip, bar code, or other means for specifically and uniquely identifying the worker. These identification aspects may include a picture or other tamper-resistant features. When a worker appears at a work site, the identification card or other identification means is scanned. The scanning device is connected in real time to the computer processing hub and hub database information regarding safety readiness. FIG. 3 illustrates the steps of this safety-readiness certification process. The worker is immediately checked for safe work readiness. The log-in system also identifies in real time the worker/employee's location. In this way, employee tracking is enhanced by further being able to confirm the safe-work readiness of that worker.

Program reciprocity within sponsor's member employers allows for the ‘shared’ cost of training employees by not having to constantly re-train them, despite employees' mobility. Work readiness statuses follow employees from employer to employer and from jobsite to jobsite. Work status validation and verification is from wherever there is Internet access, by authorized User Login ID only.

The safety related advisory board may consist of one up to many members. The members have expertise and are involved in safety related fields. The members may come from different sides of the issue including management, labor, outside consultants, and other fields. The board is an online mechanism to monitor and act on policy and safety issues derived from use of the overall system. A purpose is to minimize issues through group decisions. The board will, for example, have input into the substance of the courses that are presented to the workers. They will have input into the actual testing of those workers. They may have input into the number and quality of tests for given certification. In addition to this input the advisory board would also be available to answer questions from workers, sponsors, employers and others with respect to the safety issues. The board may field questions, alternatively, they could also have routine discussions and topics for discussion that originate with the advisory board members. In one example, the advisory board is connected via the computer processing hub and the internet with outsiders interested in the safety topics. The Advisory Group must be efficient in order to be effective, and it will work to facilitate that end, while providing access to all issues, whether they are handled immediately or placed on the Advisory Group's Agenda for discussion and decision. The Advisory Group, in one example, may be comprised of two Sub-groups:
Policy—Issues concerning implementation of the present system; i.e., vendor issues;
Safety—Issues concerning the safety components of the present system;

i.e., decisions related to the basic safety core curriculum courses.

The Advisory Group Sub-groups, both Policy and Safety, could meet as a whole. However, the Safety Group could also meet separately to determine safety related issues and will then advise the group as a whole.

While the invention has been described with reference to specific embodiments thereof, it will be understood that numerous variations, modifications and additional embodiments are possible, and all such variations, modifications, and embodiments are to be regarded as being within the spirit and scope of the invention.

What is claimed is:

1. A method for ensuring employees safe work readiness, comprising the steps of:
providing a computer processing hub adapted to store information regarding an employee in a hub database;
providing an advisory board of a plurality of members comprising safety-involved professionals, the advisory board having access to the computer processing hub;
providing a plurality of safety-related instructional courses reviewed by the advisory board;
administering a safety-related instructional course to an employee;
verifying the identity of an employee and administering a test related to safety-related subject matter to the employee;
evaluating the test results to determine a score for the employee's test answers and storing the test results in the computer processing hub database making the test results available to an employer that is evaluating the employee's safe work readiness; and
also making the employee's test results available to the employee and allowing the employee to ask questions to the advisory board regarding the safety-related subject matter;
whereby an employer and employee may use the computer processing hub as an informational resource in the field of safe work readiness.

2. A method for ensuring employees safe work readiness as described in claim 1, wherein the computer processing hub comprises a plurality of categories of viewing access.

3. A method for ensuring employees safe work readiness as described in claim 1, further comprising the steps of:
after an employee has obtained at least a predetermined score on a predetermined number of tests, certifying the safe work readiness of the employee.

4. A method for ensuring employees safe work readiness as described in claim 1, wherein the computer processing hub is a website server, and the information stored in the hub database is available on an internet website.

5. A method for ensuring employees safe work readiness as described in claim 3, wherein different employers may select different scores on the predetermined tests before declaring safe work readiness of the employee.

6. A method for ensuring employees safe work readiness as described in claim 3, wherein different employers may require different predetermined tests before declaring safe work readiness of the employee.

7. A method for ensuring employees safe work readiness as described in claim 1, further comprising the steps of:
providing an employee with an identification card that is adapted to be scanned;
providing an entry scan system at an employer's job site, the scan system adapted to read the employee's identification card; and
using the entry scan system, confirming that each employee at the employer job site is safe work ready.

8. A method for ensuring employees safe work readiness as described in claim 7, wherein the entry scan system comprises a wireless telephone communications unit, the unit having access to the hub database.

9. A method for ensuring employees safe work readiness as described in claim 1, wherein the instructional courses are offered over the website.

10. A method for ensuring employees safe work readiness at an employer's job site, comprising the steps of:
providing a computer processing hub adapted to store information regarding an employee in a hub database;
providing a plurality of safety-related instructional courses, and administering a safety-related instructional course to an employee;
verifying the identity of an employee and administering a test related to safety-related subject matter to the employee;
evaluating the test results to determine a score for the employee's test answers, and storing the test results in the hub database;
providing the employee with an identification card that is adapted to be scanned;
providing an entry scan system at an employer's job site, the scan system adapted to read the employee's identification card; and
using the entry scan system, confirming that each employee at the employer job site is safe work ready.
